(19) United States
(12) Patent Application Publication
(10) Pub. No.: US 2001/0040810 A1
(43) Pub. Date: Nov. 15, 2001

(54) Vehicle headlamp

(76) Inventor: Masahiro Kusagaya, Shizuoka (JP)

Correspondence Address: Fish & Richardson P.C., Suite 2800, 45 Rockefeller Plaza, New York, NY, 10111, US

(21) Appl. No.: 09/854,645

(22) Filed: May 14, 2001

(30) Foreign Application Priority Data
May 15, 2000 (JP) P2000-141222

(51) Int. Cl. B60Q 1/08; B60Q 1/10

(52) U.S. Cl. 362/351; 362/465; 362/539; 362/464; 362/466; 362/284; 362/324

(57) ABSTRACT

A vehicle headlamp has a unit inclination control mechanism for vertically tilting the lamp unit according to the travel conditions of a vehicle, and a luminous intensity variable control mechanism for varying the luminous intensity distribution by moving a component element of the lamp unit according to the travel conditions of the vehicle. Beam emission can be carried out at emission angles with the luminous intensity distribution conforming to the travel conditions of the vehicle by properly combining beam emission control performed by the unit inclination control mechanism and the luminous intensity variable control mechanism. The result is improved visibility of a road surface ahead of the vehicle.

### BACKGROUND OF THE INVENTION

1. Field of the Invention

The present invention relates to a vehicle headlamp housing a lamp unit within a lamp body for emitting beams forward with a predetermined luminous intensity distribution.

2. Description of the Related Art

Heretofore, there are a known vehicle headlamp housing a lamp unit within a lamp body such as disclosed in, for example JP-A-10-147175. A known vehicle headlamp is so arranged as to vertically tiltably move a lamp unit in response to a vehicle speed, a vehicle posture and the like.

However, a luminous intensity distribution is only to be vertically tilted while remaining in the same form by solely tilting a lamp unit vertically. Consequently, it is difficult to emit beams with a luminous intensity distribution according to the travel conditions of a vehicle.

### SUMMARY OF THE INVENTION

The present invention made in view of the aforementioned situation provides a vehicle headlamp which houses a lamp unit in a lamp body for emitting beams forward with a predetermined luminous intensity distribution. The headlamp is capable of emitting beams with the predetermined luminous intensity distribution and at emission angles according to the travel conditions of a vehicle.

In order to accomplish such operation, the invention is arranged so that the vertical position of a luminous intensity distribution can be changed by vertically tilting a lamp unit. In addition, the luminous intensity distribution itself can be varied by moving the component element of the lamp unit.

More specifically, a vehicle headlamp having a lamp body for housing a lamp unit for emitting beams forward with a predetermined luminous intensity distribution includes a luminous intensity variable control mechanism for varying the luminous intensity distribution by moving a component element of the lamp unit according to the travel conditions of a vehicle. The headlamp also includes a unit inclination control mechanism for vertically tilting the lamp unit according to the travel conditions of the vehicle.

The ‘lamp unit’ is not limited to any specific form but may be a so-called parabolic lamp unit having a reflector formed with a rotary parabolic surface with, for example, a rotary parabolic surface or the like as a reference. Alternately, the lamp unit may be a so-called projector type lamp unit having a light source disposed in a manner substantially coaxial with an optical axis extending in the longitudinal direction of the vehicle, a reflector for reflecting light from the light source forward closer to the optical axis, a condenser lens provided in front of the reflector, and a shade which is provided between the condenser lens and the reflector and used for shielding part of the light reflected from the reflector.

The light source of the ‘lamp unit’ is not limited to a specific one in construction, but may be a discharge light-emitting portion of a discharge bulb, a filament of an incandescent bulb such as a halogen bulb, or the like.

The phrase ‘travel conditions of a vehicle’ pertains to various conditional quantities regarding the travel of a vehicle and external information. For example, vehicle speed, a rudder angle, vehicle posture, a vehicleto-vehicle distance with respect to the vehicle and any preceding car, weather, navigation data and the like, all fall under that category.

The ‘component element’ of the lamp unit is not limited to any specific one, but may be anything that can be used to vary the luminous intensity distribution of the lamp unit by moving the component element. For example, a shade, a light source bulb, a reflector and the like can be adopted for such use.

As described in a construction of the vehicle headlamp according to the invention, the vehicle headlamp is so arranged as to vary the luminous intensity distribution by moving the component element of the lamp unit housed in the lamp body with the use of the luminous intensity variable control mechanism, and to vertically move the luminous intensity distribution by vertically tilting the lamp unit with the use of the unit inclination control mechanism. Consequently, the beam emission can be carried out at an emission angle with the luminous intensity distribution conforming to the travel conditions of the vehicle and by properly combining the beam emission control performed by the unit inclination control mechanism and the luminous intensity variable control mechanism. Such a headlamp improves the visibility of the road surface ahead of the vehicle.

With the above arrangement, the adoption of the projector type lamp unit as a lamp unit makes obtainable the following effect.

More specifically, as the vehicle headlamp according to the invention is so arranged as to move the component element of the lamp unit and to vertically tilt the lamp unit itself, a space for the purpose must be secured in the lamp body. Therefore, use of the projector type lamp unit whose lamp unit itself can be made compact results in reducing its space. In connection with the projector type lamp unit, moreover, as there are many kinds of component elements selectable as moving objects for varying their luminous intensity distributions (e.g., a condenser lens is also selectable), the luminous intensity variable control mechanism is adaptable for suitable use in the structure of the vehicle headlamp.

In this case, the adoption of a shade as the component element makes it easy to delicately vary the luminous intensity distribution by moving the shade. The result obtained is a luminous intensity distribution fit for the travel conditions of the vehicle.

The vehicle headlamp according to the invention may also be so constructed as to house a single lamp unit in the lamp body, or to house the lamp unit together with another one. With the latter arrangement, the lamp unit and the additional lamp are supported by the same unit support member, and by vertically tilting the unit support member by using the unit inclination control mechanism, the beam emission can be carried out at the emission angle according to the travel conditions of the vehicle even with respect to the addition lamp unit. Such operation further improves the visibility of the road surface ahead of the vehicle. The ‘additional lamp unit’ is not limited to any specific kind but may be, for example, a lamp unit used to emit a spot beam for increasing the light intensity in the central portion of the luminous intensity distribution or a lamp unit, used to emit beams largely expanding in left and right directions in order to secure a wider lateral diffusion angle of the luminous intensity distribution or the like.

### BRIEF DESCRIPTION OF THE DRAWINGS

FIG. 1 is an overall block diagram of a vehicle headlamp according to a first embodiment of the invention.

FIG. 2 is a cross-sectional side view of the headlamp body of the vehicle headlamp.

FIG. 3 is an enlarged sectional side view of the lamp unit of the headlamp body.

FIG. 4 is a detailed diagram of a portion of the lamp unit of FIG. 3.

FIG. 5 is a cross-sectional top view diagram taken in the direction of arrow V of FIG. 4.

FIG. 6(a) and 6(b) are diagrams showing the luminous intensity distribution emitted forward from the headlamp body.

FIGS. 7(a) and 7(b) are diagrams showing the luminous intensity distribution to illustrate the beam emission control performed by the unit inclination control mechanism of the headlamp body.

FIGS. 8(a) and 8(b) are diagrams showing the luminous intensity distribution to illustrate the beam emission control performed by the luminous intensity variable control mechanism of the headlamp body.

FIG. 9 is an elevational view of the headlamp body of a vehicle headlamp according to a second embodiment of the invention.

FIGS. 10(a) and 10(b) are diagrams of the luminous intensity distribution emitted forward from the headlamp body.

### DETAILED DESCRIPTION OF THE PREFERRED EMBODIMENTS

Embodiments of the present invention will now be described with reference to the drawings.

First, a first embodiment of the invention will be described.

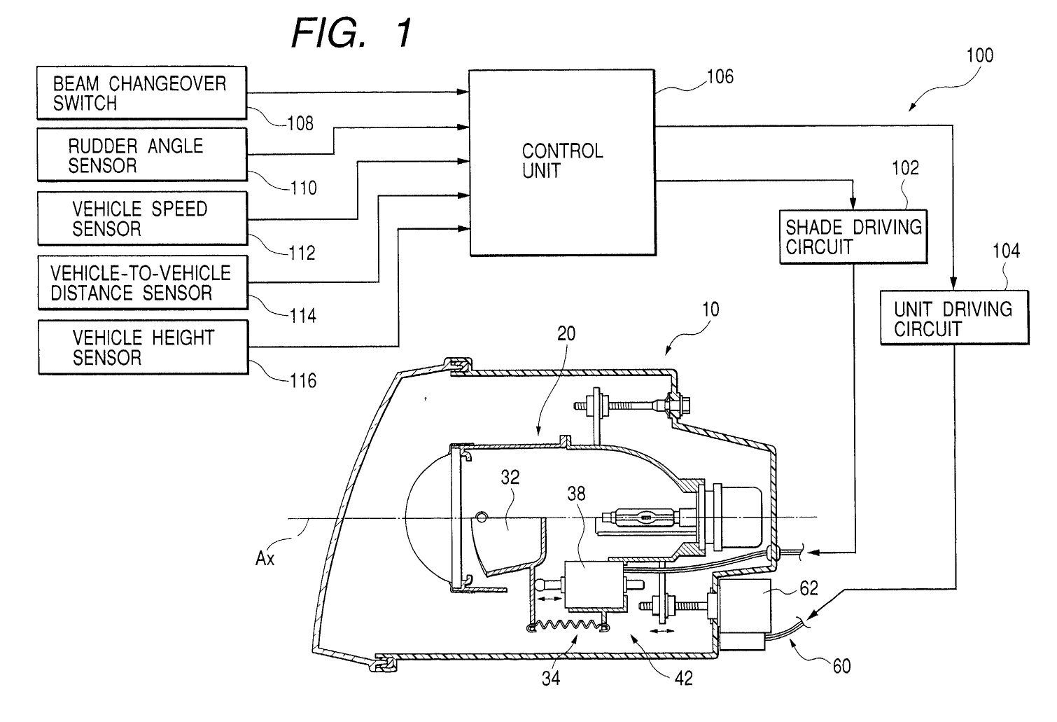

FIG. 1 is an overall block diagram of a vehicle headlamp embodying the invention.

As shown in FIG. 1, the vehicle headlamp 100 is furnished with a headlamp body 10, a shade driving circuit 102, a unit driving circuit 104, and a control unit 106. Detection signals from a beam changeover switch 108, a rudder angle sensor 110, a vehicle speed sensor 112, a vehicle-to-vehicle distance sensor 114 and a vehicle height sensor 116 are input to the control unit 106.

The beam changeover switch 108 is a switch for selectively switching low- and high-beam luminous intensity distributions. The vehicle-to-vehicle distance sensor 114 may include a millimeter wave radar and the like. The vehicle height sensor 116 may include a displacement sensor that is mounted in the suspension mechanisms of both the front and rear wheels.

In the vehicle headlamp 100, beam emission control is performed according to the travel conditions of a vehicle on the basis of a control signal from the control unit 106. The construction of the headlamp body 10 will be described before the details of beam emission control is described.

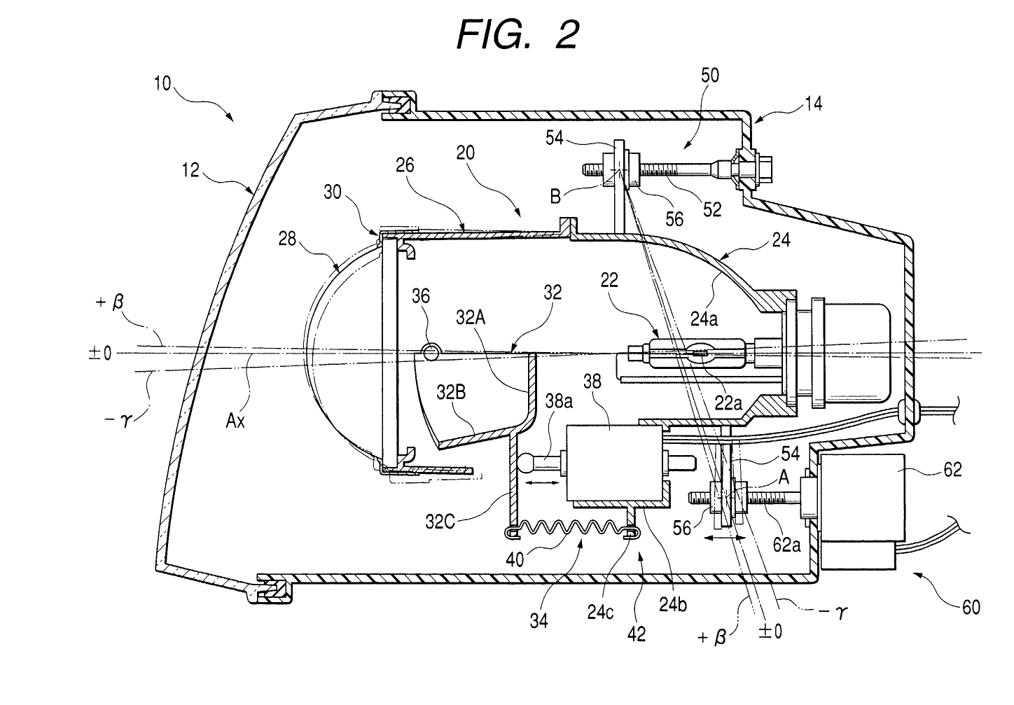

FIG. 2 is a cross-sectional side view of the headlamp body 10.

As shown in FIG. 2, a lamp unit 20 is housed in a lamp chamber formed with a plain transparent cover 12 and a lamp body 14 of the headlamp body 10.

The lamp unit 20 is supported by the lamp body 14 via an aiming mechanism 50 in such a manner that is tiltable vertically and laterally. The aiming mechanism 50 is arranged so that the aiming bracket 54 of the lamp unit 20 may be coupled via an aiming nut 56 to each aiming screw 52 rotatably fitted to a plurality of places of the lamp body 14 (however, one place is the output shaft 62a of a motor 62 which will be described later). The aiming mechanism 50 permits an initial adjustment of the optical axis Ax of the lamp unit 20.

A unit inclination control mechanism 60 of this implementation for vertically tilting the lamp unit 20 according to the travel conditions of the vehicle is provided at a vertical aiming fulcrum A in the aiming mechanism 50.

The unit inclination control mechanism 60 of this implementation comprises a motor 62 fitted to the lamp body 14, the unit driving circuit 104 connected to the motor 62, and the control unit 106. The unit inclination control mechanism 60 rotates the output shaft 62a by driving the motor 62, using the unit driving circuit 104 according to the control signal from the control unit 106, to tilt the lamp unit 20 within the range of angles from upward by β (β=1°) to downward by y (y=2°) from the initial adjustment position (the position where the optical axis Ax conforms to the longitudinal direction of the vehicle) of the lamp unit 20.

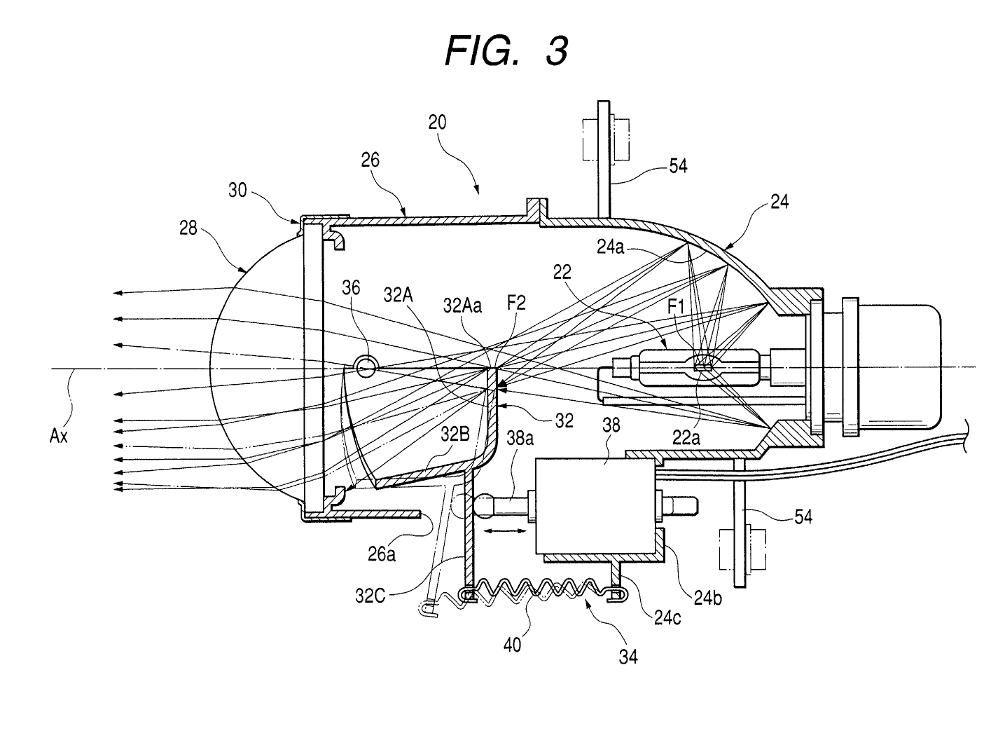

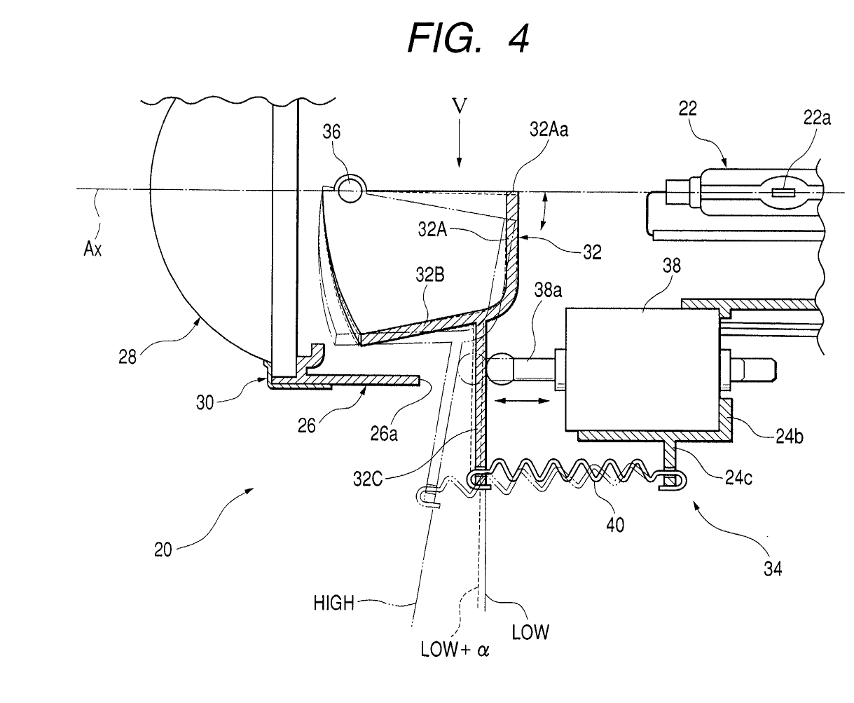

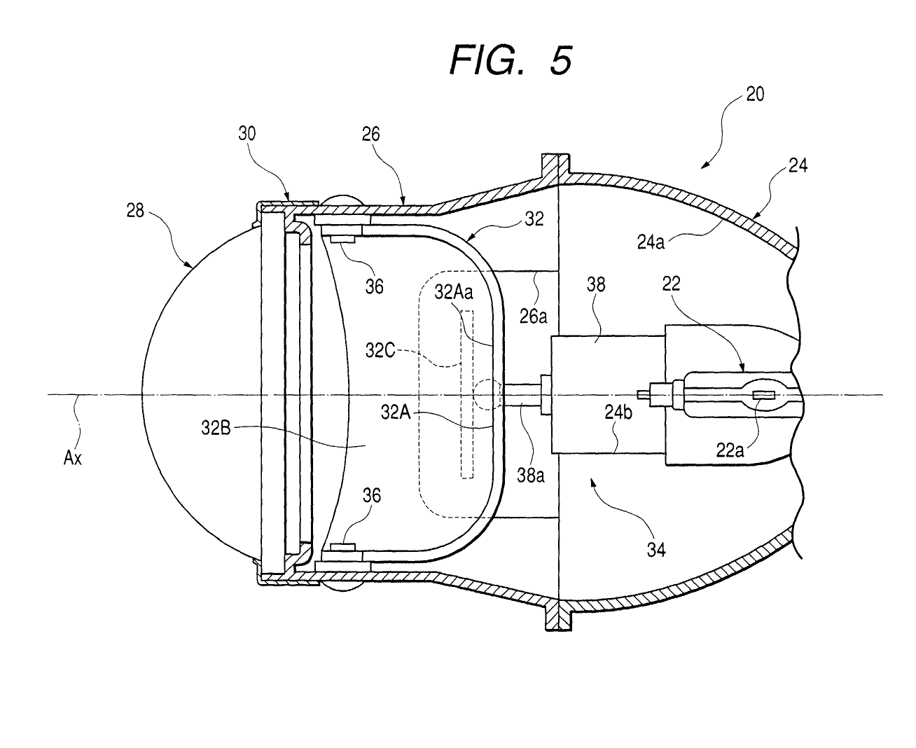

FIG. 3 is an enlarged cross-sectional side view of the lamp unit 20; FIG. 4 is a detailed view of a portion of the lamp unit of FIG. 3; and FIG. 5 is a cross-sectional top view diagram, taken in the direction of arrow V of FIG. 4.

As shown in FIG. 3, the lamp unit 20 is a projector type lamp unit having a discharge bulb 22, a reflector 24, a holder 26, a condenser lens 28, a retaining ring 30, a shade 32, and a shade driving mechanism 34.

The discharge bulb 22 may be a metal halide bulb that is fitted to the reflector 24 in such a manner that its discharge light emitting portion 22a (light source) is disposed coaxially with the optical axis Ax.

The reflector 24 has an elliptic spherical reflective surface 24a centering around the optical axis Ax. The reflective surface 24a is formed in such a way that the sectional configuration including the optical axis Ax is set elliptic and that its eccentricity is set to grow gradually greater from its vertical to horizontal section. However, the rear apex of the ellipse forming each of the sections is set at the same position. The light source 22a is disposed at a first focal point F1 of the ellipse forming the vertical section of the reflective surface 24a. Therefore, the reflective surface 24a is adapted to reflect light from the light source 22a forward toward the vicinity of the optical axis Ax and also to substantially converge the light to a second focal point F2 of the ellipse within the vertical section including the optical axis Ax.

The holder 26 has a cylindrical shape extending forward from the front end opening portion of the reflector 24 and is fixedly supported in its rear end portion, and also fixedly supports the condenser lens via the retaining ring 30 in its front end portion. Further, a cutout portion 26a is formed in the lower end portion of the holder 26.

The condenser lens 28 is a flat convex lens having a convex front surface and a flat rear surface, its rear focal point position being placed in conformity with the second focal point F2 of the reflective surface 24a of the reflector 24, whereby the condenser lens 28 allows the light reflected from the reflective surface 24a of the reflector 24 to concentrate on a point close to the optical axis Ax.

The shade 32 comprises a shade body portion 32A extending substantially along a vertical plane crossing the optical axis Ax at right angles, a substantially semi-cylindrical portion 32B extending forward from the peripheral edge portion of the shade body portion 32A, and a bracket portion 32C extending downward through the cutout portion 26a of the holder 26 from the lower end portion of the substantially semi-cylindrical portion 32B. The shade 32 is pivotally provided in the lower portion of the inner space of the holder 26. More specifically, the shade 32 is supported by the holder 26 via a pivotal pin 36 in the front upper end portions of both the left and right sides of the substantially semi-cylindrical portion 32B, so that the shade 32 is able to pivot between low- and high-beam forming positions (positions shown by solid lines) around a horizontal axis connecting both the pivotal pins 36.

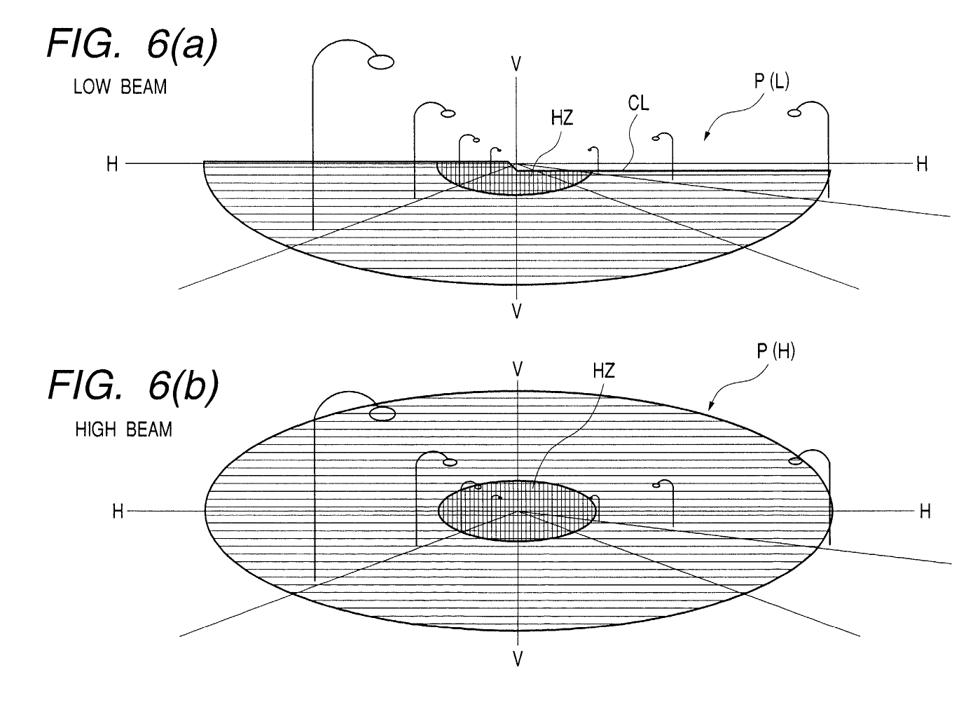

When the shade 32 is in the low-beam forming position, the upper end edge 32Aa of the shade body portion 32A is so arranged as to pass the second focal point F2 and to remove the upward light emitted from the lamp unit 20 by partly shading the light reflected from the reflective surface 24a, whereby to obtain light for low-beam emission (the beams shown by solid lines) emitted downwardly with respect to the optical axis Ax. Thus, the low-beam luminous intensity distribution P(L) of the left luminous intensity having a “Z-shaped” cut-off line (CL) (on laterally different levels) is formed as shown in FIG. 6(a). When the shade 32 is in the high-beam forming position, the shade 32 allows the upward emission light to be emitted from the lamp unit 20 by releasing the shading of the light reflected from the reflective surface 24a whereby to obtain light for high-beam emission (the beams shown in FIG. 3 by solid and chain double-dashed lines). Thus, the high-beam luminous intensity distribution P(H) is formed as shown in FIG. 6(b). Areas shown by HZ in these low- and high-beam luminous intensity distributions P(L) and P(H) are hot zones (high luminous intensity areas) in the respective luminous intensity distributions.

The shade driving mechanism 34 is provided with a motor driving unit 38 and a tension coil spring 40. The driving mechanism is used to pivot the shade 32 between the low- and high-beam forming positions and also to stop the shade 32 in any desired position therebetween. Beam switching between the low and high beams is thereby carried out and by stopping the shade 32 in an intermediate position between the low- and high-beam forming positions, beam emission can be carried out with an intermediate luminous intensity distribution between the low- and high-beam luminous intensity distributions. According to this embodiment of the invention, the shade 32 can be stopped in the intermediate position (LOW+α) closer to the high-beam forming position (HIGH) rather than the low-beam forming position as shown by a broken line in FIG. 4. The aforementioned angle α may be set at 0.5°.

The output shaft 38a of the motor driving unit 38 is disposed as to extend in parallel to the optical axis Ax, and the motor driving unit 38 is fixedly fitted in a motor housing portion 24b formed in the lower area of the reflector 24. This motor driving unit 38 is used to move the output shaft 38a in the longitudinal direction of the vehicle as a motor (not shown) operates to drive the motor driving unit 38 via a gear (not shown) such that the bracket portion 32C of the shade 32 contacts the front end spherical portion of the output shaft 38a.

The tension coil spring 40 is so arranged as to extend in parallel to the optical axis Ax and its front end portion is retained by the bracket portion 32C of the shade 32, whereas its rear end portion is retained by a tab 24c projecting downward from the motor housing portion 24b. The tension coil spring 40 resiliently urges the shade 32 toward the low-beam forming position whereby to prevent the shade 32 from becoming weak in the joints by absorbing a backlash of the motor driving unit 38.

As shown in FIG. 1, the motor driving unit 38 of the shade driving mechanism 24 is connected via the shade driving circuit 102 to the control unit 106 and driven by the shade driving circuit 102 according to control signals from the control unit 106. Thus, the shade driving mechanism 34, the shade driving circuit 102 and the control unit 106 are used to form a luminous intensity variable control mechanism 42 for varying the luminous intensity distribution of the lamp unit 20 by moving the shade 32 according to the travel conditions of the vehicle.

Beam emission control performed in the vehicle headlamp 100 according to this embodiment of the invention will now be described.

According to this embodiment of the invention, beam emission control is performed by the unit inclination control mechanism 60 and the luminous intensity variable control mechanism 42 according to the travel conditions of the vehicle.

More specifically, while the vehicle is traveling on a straight flat road at a fixed speed, the beam emission has the luminous intensity distribution as shown in FIGS. 6(a) and 6(b). At this time, the unit inclination control mechanism 60 is set in the initial adjustment position (the position where the optical axis Ax conforms to the longitudinal direction of the vehicle) of the lamp unit 20. The luminous intensity variable control mechanism 42 then moves the shade 32 to the low- or high-beam forming position in response to the operation of the beam changeover switch 108 in order to carry out the beam emission with the low-beam luminous intensity distribution P(L) as shown in FIG. 6(a) or the high-beam luminous intensity distribution P(H) as shown in FIG. 6(b).

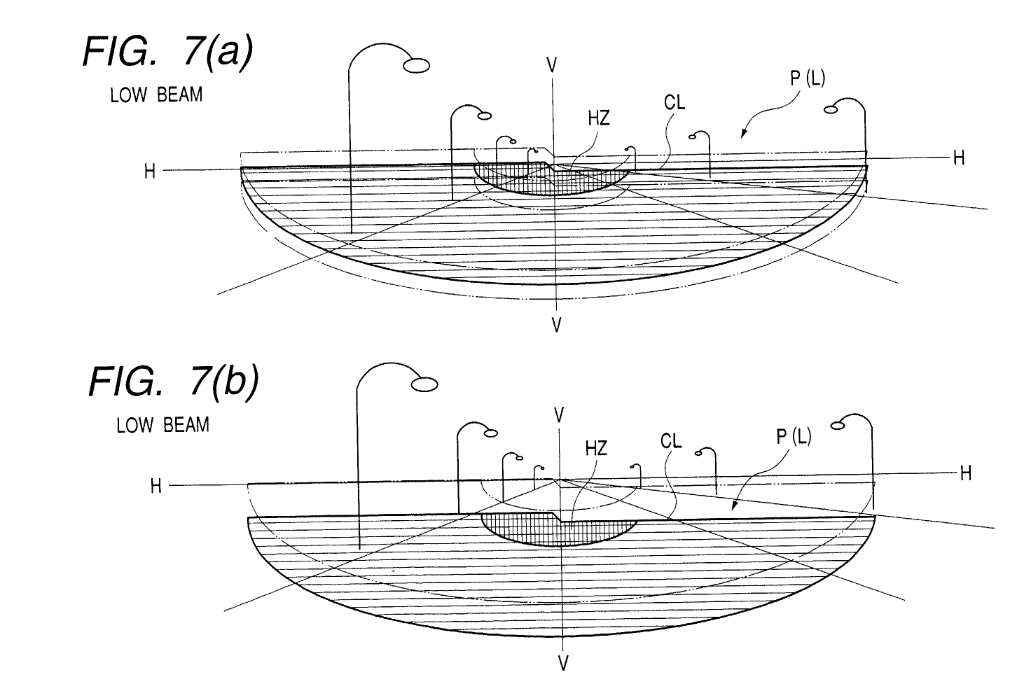

Even while the vehicle is traveling on a straight flat road, the vertical displacement of the low-beam luminous intensity distribution P(L) occurs as shown by chain double-dashed lines in FIG. 7(a) when the vehicle leans in the longitudinal direction because of an increase or decrease in its speed. Consequently, the unit inclination control mechanism 60 corrects the optical axis (so-called auto leveling) based on the longitudinal leaning of the vehicle by vertically tilting the lamp unit 20. The optical axis correction is made by the control unit 106 which calculates the longitudinal leaning angle of the vehicle according to the signal detected by the vehicle height sensor 116 arranged on each of the front and rear wheels of the vehicle, and then drives the motor 62 via the unit driving circuit 104 to an extent corresponding to the calculated value.

Performing beam emission control as described is also applied to the high-beam luminous intensity distribution P(H). Performing beam emission control is particularly important for the low-beam luminous intensity distribution P(L) having the cut-off line CL, and thus an exemplary description will now be given of the low-beam luminous intensity distribution P(L) hereinbelow.

When the vehicle speed becomes lower than a predetermined value or less (e.g., 5 km/h or less) and when a vehicle-to-vehicle distance with respect to any vehicle traveling ahead decreases to a predetermined value or less (e.g., 5 meters or less) during the travel of one's own vehicle, the unit inclination control mechanism 60 tilts the lamp unit 20 downward as much as possible so as to direct the low-beam luminous intensity distribution P(L) downward. Such operation prevents the useless upwardly-scattered light component contained in the beam emitted from the lamp unit 20 from being incident on the rear-view mirror or the like of the preceding car, and thus prevents glare from impinging on the driver of the preceding car. This optical axis correction is calculated by the control unit 106 for driving the motor 62 via the unit driving circuit 104 according to the detected signals from the vehicle speed sensor 112 and the vehicle-to-vehicle distance sensor 114.

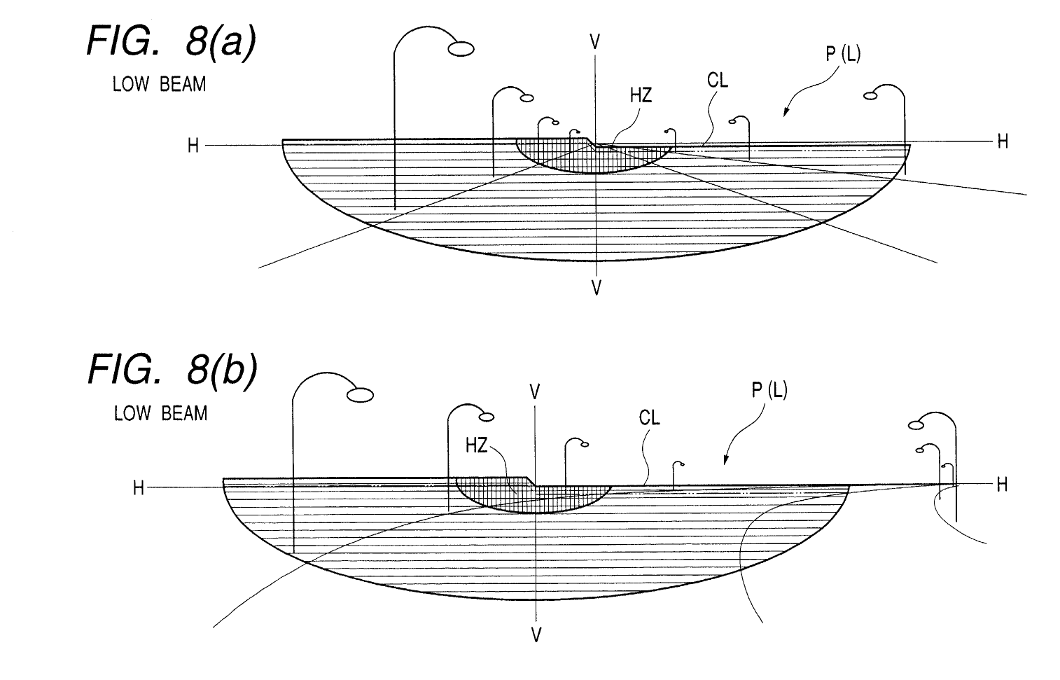

When the vehicle-to-vehicle distance with respect to the preceding car increases to a predetermined value or greater (e.g., 50 m or greater) during the travel of the vehicle, the luminous intensity variable control mechanism 42 moves the shade 32 to an intermediate position that is directed upward by 0.5° from the low-beam forming position. Thus, without changing the position of the low-beam luminous intensity distribution P(L) itself as shown in FIG. 8(a), the upward displacement of the cut-off line CL is effected by 0.5°. Thus, the visibility of a road surface far ahead of the vehicle is sufficiently enhanced as the low-beam luminous intensity distribution P(L) (particularly, the hot zone HZ) is expanded into the distance. Since the vehicle-to-vehicle distance with respect to the preceding car is normally long during high speed travel, vehicle travel safety is increased during high speed travel by sufficiently enhancing distance visibility. In this case, as the vehicle-to-vehicle distance grows with respect to the preceding car, no great glare is given to the driver of the preceding car even though the upward displacement of the cut-off line CL by 0.5° is effected. The adjustment of the cut-off line CL is made by the control unit 106 for driving the motor driving unit 38 of the shade driving mechanism 34 via the shade driving circuit 102 according to the detected signal from the vehicle-to-vehicle distance sensor 114.

The upward displacement of the position of the cutoff line CL by 0.5° can be accomplished only by tilting the lamp unit 20 upward using the unit inclination control mechanism 60 so as to effect the upward displacement of the low-beam luminous intensity distribution P(L) by 0.5°. However, using the luminous intensity variable control mechanism 42 makes it possible to expand the low-beam luminous intensity distribution P(L) (particularly, the hot zone HZ) upward while the position of the low-beam luminous intensity distribution P(L) (particularly, the position of the hot zone HZ) with respect to the road surface ahead of the vehicle is maintained in an originally designated position. Thus, distance visibility can be increased further on securing forward visibility by means of the original low-beam luminous intensity distribution P(L).

The luminous intensity variable control mechanism 42 is arranged so that even though a rightward steering operation is performed during the travel of the vehicle, the shade 32 may be moved to the upward intermediate position by 0.5° from the low-beam forming position. As shown in FIG. 8(b), the visibility of the road surface in the distance ahead of the vehicle is thereby enhanced by effecting the upward displacement of the cut-off line of the luminous intensity distribution P(L) CL by 0.5°. Moving the cut-off line CL is carried out by the control unit 106 which controls the motor driving unit 38 of the shade driving mechanism 34 via the shade driving circuit 102 according to the detected signal from the rudder angle sensor 110. In an implementation, though the cut-off line CL is moved upward when the rightward steering operation is performed, the upward movement of the cut-off line CL is not made when a leftward steering operation is performed to prevent glare from being given to the driver of an oncoming vehicle.

As described above in detail, the vehicle headlamp 100 according to this embodiment is so arranged as to vary the luminous intensity distribution by moving the shade 32 of the lamp unit 20 housed in the lamp body 14 with the use of the luminous intensity variable control mechanism 42, and to vertically move the luminous intensity distribution by vertically tilting the lamp unit 20 with the use of the unit inclination control mechanism 60. The beam emission can be carried out at the emission angle with the luminous intensity distribution conforming to the travel conditions of the vehicle, resulting in improved visibility of the road surface ahead of the vehicle.

The adoption of a projector type lamp unit as the lamp unit 20 according to this embodiment results in a compact lamp unit 20, and a compact shade driving mechanism 34 for moving the shade 32. Such design considerations increase the freedom of forming the vehicle headlamp 100.

Moreover, the adoption of the shade 32 as a component element for varying the luminous intensity distribution makes it easy to delicately vary the position of the cut-off line CL by moving the shade 32, whereby a suitable low-beam luminous intensity distribution P(L) is obtainable depending on the travel conditions of the vehicle.

A second embodiment of the invention will now be described.

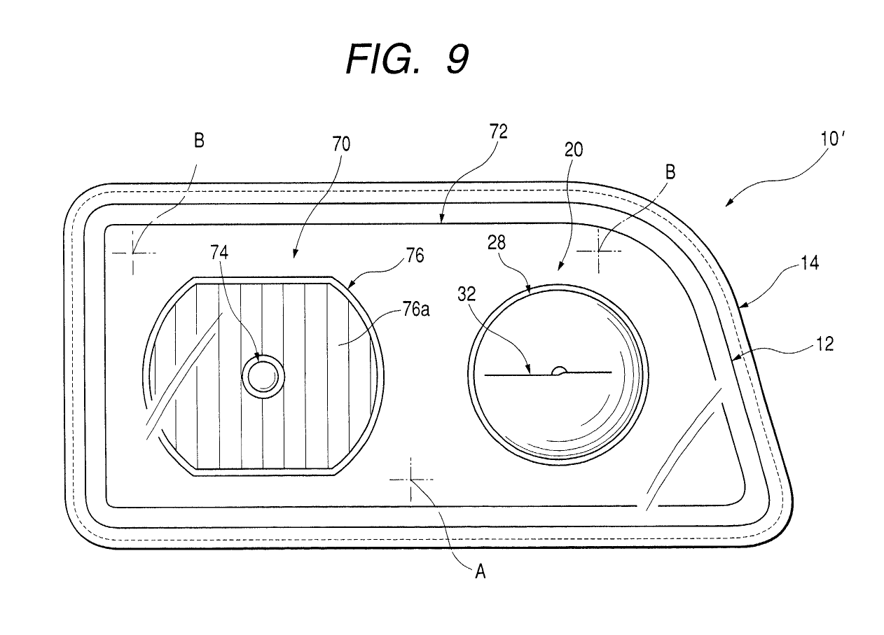

FIG. 9 is an elevational view of a headlamp body 10′ of a vehicle headlamp according to this second embodiment of the invention.

FIG. 9 shows the lamp unit 20 housed in the lamp chamber formed with a plain transparent cover 12 and the lamp body 14 as in the first embodiment of the invention, and another lamp unit 70 for wide diffusive emission together with the lamp unit 20 supported by a unit support member 72 and housed in the light chamber according to this embodiment. Further, the unit support member 72 is vertically tilted by a unit inclination control mechanism (not shown) which is similar to that described in the first embodiment of the invention, and is provided at a vertical aiming point A of application. This tilting movement is made round the center of a straight line connecting vertical aiming points B in two lateral places.

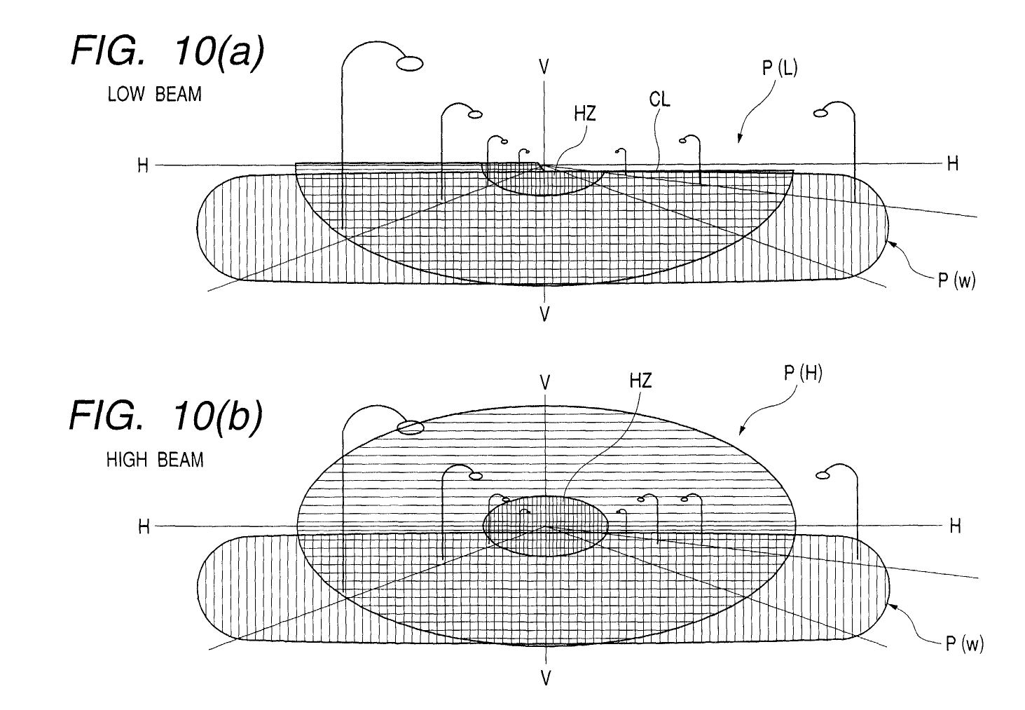

The lamp unit 70 for wide diffusive emission may be a parabolic lamp unit and includes a halogen bulb 74, and a reflector 76. The reflector 76 has a reflective surface 76a formed with a rotary parabolic surface as a reference and used to reflect light from the halogen bulb 74 forward laterally and diffusively. With this arrangement, as shown in FIGS. 10(a) and 10(b), there is formed a wide diffusive luminous intensity distribution P(w) expanding laterally farther than the low- and high-beam luminous intensity distributions P(L) and P(H) formed by the lamp unit 20. The wide diffusive luminous intensity distribution P(W) is set so that its upper edge may be substantially equal in height to the right-side lower stepped portion of the cutoff line CL of the low-beam luminous intensity distribution P(L).

The additional formation of the wide diffusive luminous intensity distribution P(w) allows the road surface ahead of the vehicle to be widely laterally illuminated. The frontal area of the road surface ahead of the vehicle can be illuminated more brightly by setting a smaller lateral angle of diffusion with respect to the low- and high-beam luminous intensity distributions P(L) and P(H), so that the visibility of the road surface ahead of the vehicle is sufficiently enhanced.

Since the lamp unit 70 together with the lamp unit 20 is vertically tilted when the unit support member 72 is vertically tilted, the wide diffusive luminous intensity distribution P(w) can vertically be tilted along with the low- or high-beam luminous intensity distribution P(L) or P(H) when the beam emission control is performed by the unit inclination control mechanism. Such operation further improves the visibility of the road surface ahead of the vehicle.

What is claimed is:

1. A vehicle headlamp having a lamp body for housing a lamp unit for emitting beams forward with a predetermined luminous intensity distribution, comprising:
a luminous intensity variable control mechanism for varying said luminous intensity distribution by moving a component element of said lamp unit according to the travel conditions of a vehicle; and
a unit inclination control mechanism for vertically tilting said lamp unit according to the travel conditions of the vehicle.

2. The vehicle headlamp according to claim 1, wherein said lamp unit comprises:
a light source disposed in a manner substantially coaxial with an optical axis extending in a longitudinal direction of the vehicle;
a reflector for reflecting light from said light source forward closer to said optical axis;
a condenser lens provided in front of said reflector; and
a shade which is provided between said condenser lens and said reflector and used for shielding part of the light reflected from said reflector.

3. The vehicle headlamp according claim 2, wherein said luminous intensity variable control mechanism is so arranged as to vary said luminous intensity distribution by moving said shade.

4. The vehicle headlamp according to claim 1,
wherein said lamp unit together with at least one other lamp unit is supported by a unit support member, and
wherein said unit inclination control mechanism operates to vertically move said unit support member.

5. The vehicle headlamp according to claim 2,
wherein said lamp unit together with at least one other lamp unit is supported by a unit support member, and
wherein said unit inclination control mechanism operates to vertically move said unit support member.

6. The vehicle headlamp according to claim 3,
wherein said lamp unit together with at least one other lamp unit is supported by a unit support member, and
wherein said unit inclination control mechanism operates to vertically move said unit support member.

7. A vehicle headlamp comprising:
a lamp body including a lens, a lamp unit, and a support member;
a luminous intensity variable control mechanism for varying a luminous intensity distribution of the headlamp according to travel conditions; and
a unit inclination control mechanism for vertically tilting the lamp unit about the support member according to travel conditions.

8. The vehicle headlamp of claim 7 wherein the lamp unit comprises a light source disposed substantially coaxial with an optical axis that extends in a longitudinal direction of the vehicle.

9. The vehicle headlamp of claim 8 wherein the lamp unit further comprises:
a reflector;
a condenser lens connected to the front of the reflector; and
a shade provided between the condenser lens and reflector.

10. The vehicle headlamp of claim 9 wherein the luminous intensity variable control mechanism is configured to move the shade.

11. The vehicle headlamp of claim 7 further comprising at least one additional lamp unit connected to the support member.

12. A method for controlling the beam emitted from a vehicle headlamp comprising:
moving a component of a lamp unit according to vehicle travel conditions to vary a luminous intensity distribution of the beam; and
tilting the lamp unit vertically according to the vehicle travel conditions.

13. The method of claim 12, wherein the lamp unit is tilted downward as much as possible when a vehicle to vehicle distance is less than a predetermined value.

14. The method of claim 12, wherein the lamp unit is tilted downward as much as possible when the vehicle is traveling at a speed that is less than a predetermined value.

15. The method of claim 12, wherein the lamp unit is tilted to a position that is intermediate of a low beam position and a high beam position when the vehicle to vehicle distance increases to at least a predetermined value.

16. The method of claim 15, further comprising moving the component of the lamp unit to expand the low-beam luminous intensity distribution.

17. The method of claim 12, wherein the component of the lamp unit is tilted when a turn steering operation occurs during travel of the vehicle.

18. The method of claim 12 further comprising tilting at least one further lamp unit to provide a wide diffusion luminous intensity distribution.
